(19) United States
(12) Patent Application Publication
(10) Pub. No.: US 2022/0287495 A1
(43) Pub. Date: Sep. 15, 2022

(54) Cartridge System and Method for Producing a Cartridge System

(71) Applicant: Freezio AG, Amriswil (CH)

(72) Inventors: Marc Krüger, Bergisch Gladbach (DE); Günter Empl, Bergisch Gladbach (DE)

(21) Appl. No.: 17/635,454

(22) PCT Filed: Aug. 24, 2020
(86) PCT No.: PCT/EP2020/073627

§ 371 Date: Feb. 15, 2022

(30) Foreign Application Priority Data
Aug. 22, 2019 (DE) 10 2019 212 583.2

(51) Int. Cl. A47J 31/40; B67D 1/00; B65D 85/804; B67D 1/08

(52) U.S. Cl. CPC A47J 31/407; B67D 1/0079; B65D 85/8052; B67D 1/0046; B67D 1/0804; B67D 2001/0814

(57) ABSTRACT

The invention relates to a cartridge system (1) for producing a bever-age (70), wherein the cartridge system (1) can be introduced into a beverage preparation machine (3). The invention also relates to a cartridge (2) which comprises a reservoir (6) filled with a beverage substance (7) and to a cartridge receiving region (10) connected to the cartridge (2). The cartridge receiving region (10) has a mixing chamber (8) which can be fluidically connected to the reservoir (6) and a fluid feed line (12) which opens into the mixing chamber (8). The mixing chamber (8) has a beverage discharge (11), through which the beverage (70) made of the mixture of the beverage substance (7) and the fluid supplied by the fluid feed line (12) in the mixing chamber (8) is dispensed, said beverage discharge (11) comprising a tubular line piece (30). The invention is characterized in that the line piece (30) is designed such that the main extension direction (31) of the line piece (30) runs at an angle α (33) to the longitudinal axis (32) of the cartridge (2).

### PRIOR ART

The present invention proceeds from a cartridge system for producing a beverage, wherein the cartridge system is insertable into a beverage preparation machine, has a cartridge comprising a reservoir filled with a beverage substance, and has a cartridge receptacle connected to the cartridge, wherein the cartridge receptacle has a mixing chamber fluidly connectable to the reservoir and a fluid feed opening into the mixing chamber, wherein the mixing chamber has a beverage outlet through which the beverage made of a mixture of the beverage substance and the fluid supplied by the fluid feed in the mixing chamber is discharged, and wherein the beverage outlet comprises a tubular line piece.

Such systems are known from the prior art, for example, from the documents WO 2017/121 802 A1, WO 2017/121 801 A1, WO 2017/121 801 A1, WO 2017/121 799 A1, WO 2017/121 798 A1, WO 2017/121 797 A1, WO 2017/121 796 A1 and WO 2019/002 293 A1 and are used to produce beverages from pre-portioned cartridges. The production of beverages with such systems is extremely convenient for the user, since he only has to insert a cartridge and press a start button. The beverage preparation machine then takes over making the same in a fully automated manner, that is to say in particular that the beverage substance is mixed with a predetermined amount of liquid, in particular cold and carbonated water, and is introduced into a drinking vessel. In this way, mixed beverages in particular can be produced much more easily, quickly and with little effort for the user. The user can in this case select from a large number of different cartridges, so that he can produce different drinks as desired.

A major challenge in such systems is to be able to use only one single beverage preparation machine and different cartridge systems to produce a wide variety of different beverages, each of which is prepared in a visually and tastefully appealing manner. For example, for some types of beverage, a slight foaming on the surface of the beverage produced is desirable, such as for beer, while for other beverages, foaming should be avoided, such as for tea. In addition, it must be ensured that, for those types of beverage that are prone to strong foaming, such as beer and sparkling wine, there is no excessive foaming when the produced beverage is poured into the user's glass or drinking vessel.

### SUMMARY OF THE INVENTION

Therefore, it is an object of the present invention to provide a cartridge system for the production of a beverage in a beverage preparation machine, in which the production of a beverage with an appealing appearance and taste is achieved and, in particular, the different formation of foam of different beverage substances is taken into account.

This object is achieved by a cartridge system according to claim 1.

Compared with the prior art, the cartridge system according to the invention has the advantage that the line piece and thus the beverage outlet runs at an angle to the longitudinal axis, thus is inclined relative to the longitudinal axis. This has the effect that the beverage dispensing jet emerging from the beverage outlet in the direction of the drinking vessel strikes the surface of the beverage at an angle. This prevents excessive foaming. It has been shown that in particular in this case an angle α runs between 5 and 85 degrees, preferably between 15 degrees and 75 degrees and particularly preferably between 25 and 65 degrees. The term “tubular line piece” means in particular that the line piece has a channel closed perpendicular to the direction of flow, through which the beverage can leave the mixing chamber. This channel can initially have any cross-sectional shape and need not necessarily be circular.

According to a preferred embodiment of the present invention, provision is made for the angle α to be between 40 and 85 degrees, preferably between 60 and 85 degrees, and particularly preferably between 70 and 80 degrees, especially if the beverage substance comprises beer-containing or beer-like substances, tea or sparkling wine. These beverage substances tend to foam excessively, which would result in too much foam in the drinking vessel when the beverage dispensing jet is directed vertically into the drinking vessel. The implementation of the angle α within the aforementioned limits advantageously leads to reduced foaming and thus to a visually appealing beverage in the drinking vessel. In particular, an angle α between 70 and 80 degrees results in the beverage dispensing jet being directed against the wall of the drinking vessel, which greatly reduces foaming. The angle α is most preferably about 75±2 degrees.

According to a preferred embodiment of the present invention, provision is made for the angle α to be between 20 and 60 degrees, preferably between 25 and 55 degrees, more preferably between 30 and 50 degrees, and most particularly at substantially 40 degrees, especially if the beverage substance comprises a particularly sugary and non-alcoholic syrup, or a caffeinated concentrate. These “flatter” angles between the main extension direction and the longitudinal axis ensure that a somewhat more “vertical” alignment of the beverage dispensing jet is realized for such beverage substances that tend to foam less, such as in particular sugary and non-alcoholic syrup or caffeinated concentrates, thus favoring a light and gentle foaming.

According to a preferred embodiment of the present invention, provision is made for the angle α to change along the main extension direction of the line piece, in particular to decrease or increase. It is conceivable for strongly foaming beverage substances, such as beer-containing or beer-like substances, tea or sparkling wine, that initially a smaller angle α between 20 and 60 degrees and subsequently a larger angle α between 70 and 80 degrees is implemented in the main flow direction of the beverage in order to direct the beverage dispensing jet accordingly. It is conceivable that the tubular line piece thus has a bend or curve in its course.

According to a further subject matter of the present invention or a further preferred embodiment of the present invention, provision is made for a cartridge system according to the preamble of claim 1 or the cartridge system described above, wherein the line piece has an inner cross-section perpendicular to its main extension direction, which has an oval, circular, angular, triangular, quadrangular, pentagonal, hexagonal, octagonal, trapezoidal, star-shaped, slit-shaped and/or ring-shaped form. In this way, too, the different foaming behavior of various beverage substances can be taken into account. It is conceivable for the shape of the cross-section to preferably change along the main extension direction of the line piece, in particular from an angular or slit-shaped shape to a round or oval shape. In this way, a comparatively open cross-section with an oval, circular, quadrangular or polygonal shape can be used in particular for strongly foaming beverage substances, such as substances containing or similar to beer, tea or sparkling wine, while a triangular, slit-shaped or annular shape can be realized for beverage substances with little foaming, such as in particular sugary and non-alcoholic syrup or caffeinated concentrates.

Preferably, the line piece has an inner contour for bursting foam bubbles, preferably in the form of an edge or tip extending in the main direction of extension. In a preferred manner, the foam bubbles burst upon contact with such, in particular, sharp-edged edges or tips, thereby reducing foaming or the proportion of foam. This is particularly preferred for strongly foaming beverage substances, such as beer-containing or beer-like substances, tea or sparkling wine. It is conceivable for the shape of the inner contour to change along the main extension direction. In the case of a star-shaped inner cross-section, the edges of the star preferably form the inner contour for bursting the foam bubbles.

According to a further subject matter of the present invention or a further preferred embodiment of the present invention, provision is made for a cartridge system according to the preamble of claim 1 or the cartridge system described above, wherein the line piece has an internal cross-section perpendicular to its main extension direction, the cross-sectional area of which changes along the main extension direction of the line piece, in particular decreases or increases. The cross-sectional area comprises in particular between 5 and 200 square millimeters, preferably between 10 and 150 square millimeters and particularly preferably between 25 and 125 square millimeters. It is conceivable that the cross-sectional area increases if the beverage substance comprises beer-containing or beer-like substances, tea or sparkling wine. When the cross-section, in particular the shape or the area, is changed within the meaning of the present invention, the main direction of extension is determined in particular by the course of the lower wall of the line piece.

According to a preferred embodiment of the present invention, provision is made for the cross-sectional area to be between 50 and 200 square millimeters, preferably between 75 and 150 square millimeters, in particular if the beverage substance comprises beer-containing or beer-like substances, tea or sparkling wine. According to a preferred embodiment of the present invention, it is further provided that the cross-sectional area is between 10 and 125 square millimeters, preferably between 50 and 100 square millimeters, in particular if the beverage substance comprises a particularly sugary and non-alcoholic syrup or a caffeinated concentrate. Advantageously, the larger opening cross-section leads to reduced foaming in the drinking vessel in the case of highly foaming beverage substances, such as beer-containing or beer-like substances, tea or sparkling wine, while in the case of less foaming beverage substances, such as in particular sugary and non-alcoholic syrup or caffeinated concentrates, the smaller cross-section leads to low and appealing foaming.

According to a further subject matter of the present invention or a further preferred embodiment of the present invention, provision is made for a cartridge system according to the preamble of claim 1 or the cartridge system described above, wherein the line piece has a length parallel to its main extension direction comprising between 2 and 40 millimeters, preferably between 3 and 20 millimeters, more preferably between 4 and 15 millimeters. According to a preferred embodiment of the present invention, provision is made for the length to be between 10 and 30 millimeters and preferably between 10 and 20 millimeters, in particular if the beverage substance comprises beer or beer-like substances, tea or sparkling wine. According to a preferred embodiment of the present invention, further provision is made for the length to be between 2 and 30 millimeters and preferably between 5 and 10 millimeters, in particular if the beverage substance comprises a particularly sugary and non-alcoholic syrup or a caffeinated concentrate. Advantageously, in the case of highly foaming beverage substances, such as beer-containing or beer-like substances, tea or sparkling wine, the longer length ensures reduced foaming in the drinking vessel, while in the case of less foaming beverage substances, such as in particular sugary and non-alcoholic syrups or caffeinated concentrates, the shorter length results in low and appealing foaming.

In principle, provision is in particular made for the shape of the cross-section and/or the angle α and/or the cross-sectional area and/or the length to be formed in each case as a function of the beverage substance.

According to a preferred embodiment of the present invention, provision is made for mixing and/or turbulence elements to be arranged within the line piece. Preferably, an additional swirling and mixing of the beverage and in particular of the beverage substance with the fluid can thus take place in the line piece. Such a mixing and/or turbulence element can be realized in particular in the form of a baffle element onto which the beverage flow bounces when passing through the line piece and thus ensures additional turbulence. This is particularly preferred for low-foaming beverage substances such as, in particular, sugary and non-alcoholic syrup or caffeinated concentrates.

According to a preferred embodiment of the present invention, provision is made for the beverage outlet to consist exclusively of the tubular line piece. In this embodiment, the cartridge system and in particular the beverage preparation machine advantageously do not have any additional components through which the beverage is directed towards the drinking vessel. The beverage coming from the mixing chamber flows exclusively through the tubular line piece and from there directly as a beverage dispensing jet into the drinking vessel or onto a wall of the drinking vessel.

According to a further subject matter of the present invention or a further preferred embodiment of the present invention, provision is made for a cartridge system according to the preamble of claim 1 or the cartridge system described above, wherein the line piece has a wall which is permeable to air and, in particular, porous or penetrated by at least one relief opening. In a preferred manner, pressure relief thus already takes place in the line piece, whereby a more continuous pressure reduction takes place and increased foaming is prevented. Advantageously, the more continuous pressure reduction in the line piece ensures reduced foaming in the drinking vessel in the case of strongly foaming beverage substances, such as beer-containing or beer-like substances, tea or sparkling wine. Preferably, the porosity of the wall and/or the number of relief openings in the wall and/or the diameter of the relief openings changes or decreases along the main extension direction of the line piece.

According to a preferred embodiment of the present invention, provision is made for the further line piece to have an inner contour for bursting foam bubbles, preferably in the form of an edge or tip extending in the main direction of extension. As already explained above in connection with the line piece, the further line piece could alternatively or additionally also be provided with such an inner contour for bursting the foam bubbles. In a preferred manner, the foam bubbles burst when they come into contact with such edges or tips, in particular those with sharp edges, thus reducing foaming or the proportion of foam. This is particularly preferred for strongly foaming beverage substances, such as beer-containing or beer-like substances, tea or sparkling wine. It is conceivable that the shape of the inner contour changes along the main extension direction. In the case of a star-shaped inner cross-section, the edges of the star preferably form the inner contour for bursting the foam bubbles.

According to a preferred embodiment of the present invention, provision is made for the further line piece to have a wall that is permeable to air and, in particular, porous or penetrated by at least one relief opening. In a preferred manner, pressure relief thus already takes place in the line piece, whereby a more continuous pressure reduction takes place and increased foaming is prevented. Advantageously, the more continuous pressure reduction in the line piece ensures reduced foaming in the drinking vessel in the case of strongly foaming beverage substances, such as beer-containing or beer-like substances, tea or sparkling wine. Preferably, the porosity of the wall and/or the number of relief openings in the wall and/or the diameter of the relief openings changes or decreases along the main extension direction of the line piece.

According to a preferred embodiment of the present invention, provision is made for the further line piece to have a wall that is permeable to air and, in particular, porous or penetrated by at least one relief opening. It is conceivable for the porosity of the wall and/or the number of relief openings in the wall and/or the diameter of the relief openings to change and preferably increase along the main extension direction.

According to a preferred embodiment of the present invention, provision is made for the beverage outlet to comprise a further line piece which adjoins the tubular line piece in the direction of flow. In this variant, the beverage outlet is constructed in particular in two parts from the line piece and the further line piece.

According to a preferred embodiment of the present invention, provision is made for the further line piece to be configured as a channel piece which is open on one side and, in particular, open at the top. In this way, a large pressure loss is already achieved at the transition from the line piece to the further line piece, so that excessive foaming is prevented, in particular if the beverage substance comprises beer-containing or beer-like substances, tea or sparkling wine.

According to a preferred embodiment of the present invention, provision is made for the further line piece to be a closed channel having an internal cross-section perpendicular to its main direction of extension, which has an oval, circular, angular, triangular, quadrangular, pentagonal, hexagonal, octagonal, trapezoidal, star-shaped, slit-shaped and/or annular shape.

According to a preferred embodiment of the present invention, provision is made for the further line piece to be configured such that a main extension direction of the further line piece is at an angle β to a longitudinal axis of the cartridge, wherein the angle β is not equal to the angle α. It is conceivable for the angle β to be larger than the angle α, in particular if the beverage substance comprises beer-containing or beer-like substances, tea or sparkling wine, and for the angle β to be smaller than the angle α, in particular if the beverage substance comprises a particularly sugary and non-alcoholic syrup or a caffeinated concentrate. In particular, provision is made for the angle α to be between 10 and 60 degrees, preferably between 2 and 55 degrees, particularly preferably between 3 and 50 degrees, and for the angle β to be between 40 and 85 degrees, preferably between 60 and 85 degrees, and particularly preferably between 70 and 80 degrees, particularly if the beverage substance comprises beer-containing or beer-like substances, tea or sparkling wine.

According to a preferred embodiment of the present invention, provision is made for the further line piece to have a length parallel to its main extension direction, comprising between 2 and 40 millimeters, preferably between 3 and 20 millimeters, more preferably between 4 and 15 millimeters.

According to a preferred embodiment of the present invention, provision is made for the line piece to have a length parallel to its main direction of extension, which is between 2 and 10 millimeters, and for the further line piece to have a length parallel to its main direction of extension, which is between 10 and 20 millimeters, in particular if the beverage substance comprises beer-containing or beer-like substances, tea or sparkling wine.

According to a preferred embodiment of the present invention, provision is made for the beverage outlet to have a flow resistance adapted to the beverage substance.

According to a preferred embodiment of the present invention, provision is made for the line piece to have a flow resistance which differs from a flow resistance of the further line piece, preferably the flow resistance of the line piece being greater than the flow resistance of the further line piece, in particular if the beverage substance comprises beer-containing or beer-like substances, tea or sparkling wine.

According to a preferred embodiment of the present invention, provision is made for the cartridge to comprise a cup-shaped main body. The cup-shaped main body is preferably produced by deep-drawing, which advantageously enables comparatively inexpensive and rapid production. In particular, the cartridge is thus necessarily hermetically sealed on one side, whereby a particularly stable configuration of the cartridge is realized. Preferably, the main body is cup-shaped with a cylindrical cartridge wall, which is closed on one side by a cartridge bottom, wherein the cartridge wall and the cartridge bottom are formed in particular in one piece. It is conceivable that the cartridge wall and the cartridge bottom consist of one piece and in particular both of aluminum, in that the main body is deep-drawn from a sheet of aluminum.

As an alternative to deep drawing, the main body can also be formed by bending an aluminum sheet into a cylindrical tube and then bonding, welding and/or pressing the abutting sides of the aluminum sheet bent into the tube together to produce a main body with a longitudinal seam. In addition, the cartridge bottom is formed as a separate lid body, in particular by deep drawing or impact extrusion of a further aluminum sheet. This cartridge bottom, which is configured as a separate lid body, can then be slipped over that end of the cartridge wall which is bent towards the tube and faces away from the cartridge receptacle, and can there be circumferentially bonded, welded and/or pressed to the cartridge wall. In particular, the lid body is crimped onto the tubular cartridge wall to form the cartridge bottom.

According to a preferred embodiment of the present invention, provision is made for the main body to be closed in its initial position on its side opposite the cartridge bottom by a sealing element. In a preferred manner, the sealing element ensures that the beverage substance remains within the reservoir before the start of the beverage production process, where it is hermetically sealed for long shelf life and consistent flavor.

According to a further preferred embodiment of the present invention, provision is made for the sealing element to have an in particular rigid or semi-rigid sealing body with a through-opening. In particular, the sealing element is made of aluminum and is attached to the main body. It is conceivable for the sealing body to be crimped, bonded, clamped, welded and/or pressed to the main body. The through-opening is formed either centrally or offset from the center in the sealing body. The sealing body is thus disk-shaped and/or ring-shaped. Alternatively, it is conceivable for the sealing body also to be cup-shaped, with the peripheral part projecting from the cup bottom running parallel to the cartridge wall and being pressed or crimped to this part of the cartridge wall. In particular, the part projecting from the cup base is arranged on the inner side of the cartridge wall in order to give the cartridge an aesthetically pleasing outer appearance.

According to a preferred embodiment of the present invention, provision is made for the sealing element to comprise a sealing foil which closes the through-opening in the initial position of the cartridge system, wherein the sealing foil is preferably a plastic foil, an aluminum foil or a multilayer foil made of plastic and/or aluminum. In this way, despite the through-opening in the sealing body, a hermetic seal of the reservoir is achieved, wherein during the beverage production process the sealing foil can be easily perforated by a piercing spike (see below) of the cartridge receptacle in order to transfer the beverage substance from the reservoir into the mixing chamber of the cartridge receptacle as quickly as possible. Preferably, a circumferential edge of the sealing foil is attached to the sealing element, in particular bonded, sealed and/or welded.

According to a preferred alternative embodiment of the present invention, provision is made for the sealing element to comprise a sealing foil, preferably a plastic foil, an aluminum foil or a multilayer foil made of plastic and/or aluminum, which is attached in particular to the edge of the cartridge wall. In this embodiment, the sealing element does not have an additional sealing body, but the opening of the main body is hermetically sealed directly and in particular exclusively by the sealing foil, which is attached directly to the edge of the cartridge wall. Preferably, a circumferential peripheral fastening region of the sealing element is crimped, bonded, sealed and/or welded to the cartridge wall and in particular to the edge of the cartridge wall.

It is conceivable for the fastening region to extend at least partially parallel to the cartridge wall on the inside or outside of the cartridge wall. In this case, the sealing foil is also cup-shaped or formed. It is conceivable for the sealing foil also to be deep-drawn into this shape.

According to a preferred alternative embodiment of the present invention, provision is made for a connecting means, in particular a latching bead, a latching bulge or an undercut, to be provided at the edge of the cartridge wall, in particular circumferentially, for connecting the cartridge to the cartridge receptacle. Preferably, the cartridge receptacle has a mating connecting means, in particular a further latching bead, a latching bulge or an undercut, which is in particular complementary to the connecting means and is connected to the connecting means in a form-fitting, force-fitting and/or material-fitting manner. Preferably, a stable and inexpensive connection between the cartridge and the cartridge receptacle can thus be achieved.

According to a preferred alternative embodiment of the present invention, provision is made for the fastening region to be arranged at least partially between the connecting means and the mating connecting means, and in particular to be clamped, welded and/or bonded in place. In a preferred manner, the sealing element, in particular the edge of the sealing body or the edge of the sealing foil, is additionally fixed between the connecting means and the mating connecting means, i.e. from both sides, during the beverage production process. A comparatively large overpressure can thus be generated inside the reservoir without the risk of the sealing element detaching from the cartridge wall. Alternatively, it is also conceivable for the fastening region to be located on the inside of the cartridge wall, so that the edge of the cartridge wall is arranged between the fastening region and the cartridge receptacle. In this case, therefore, the connecting means is arranged between the fastening means and the mating connecting means. In this way, too, a particularly stable connection can be achieved between the main body, cartridge receptacle and sealing element. In addition, the preferably circumferential connecting means and/or mating connecting means of this embodiment can also be configured as a latching bead, latching bulge, undercut or the like. It is particularly preferred that both the fastening region of the sealing element and the edge region of the sealing foil are arranged between the connecting means and the mating connecting means. According to a preferred alternative embodiment of the present invention, provision is made for the cartridge receptacle to have a basic structure which is preferably made at least partially and in particular entirely of plastic. This advantageously achieves a low-cost production. In particular, the basic structure has a cup-shaped configuration the open side of which is aligned in the direction of the cartridge, wherein a beverage outlet opening and an outwardly open spike guide are formed on a bottom side opposite the cartridge, and wherein a fluid feed is formed on the bottom side or a side wall of the basic structure. This cartridge receptacle has the advantage that the fluid feed does not open into the reservoir of the cartridge, but into the mixing chamber separated from the reservoir. This prevents the fluid feed from causing back contamination of the beverage preparation machine during the beverage preparation process. For this purpose, the reservoir is not flushed by the fluid, but rather the beverage substance and the fluid enter the mixing chamber of the cartridge receptacle separately from each other. The fluid is led directly into the mixing chamber, while the beverage substance is transferred into the mixing chamber independently of the fluid. In particular, a displaceably mounted piercing spike is arranged within the spike guide for this purpose, wherein the piercing spike is displaceable between a retracted position, in which the piercing spike is spaced apart from the sealing foil, and an extended position, in which the piercing spike pierces the sealing foil and projects into the reservoir. In the initial state of the cartridge system, the piercing spike is thus in the retracted position so that the reservoir is hermetically sealed by the sealing foil, and can be transferred from the retracted position to the extended position to open the sealing element of the cartridge. In the extended position, the sealing element is perforated by the piercing spike so that the beverage substance passes the sealing element through in particular at least one lateral channel on the piercing spike into the mixing chamber. Thus, a simple and reliable opening of a previously aroma-tight sealed cartridge in a beverage preparation machine is made possible. In addition, it has been shown that back-contamination of the beverage preparation machine is prevented, in particular because no overpressure acting directly on the fluid feed is generated in the reservoir. The configuration of the mixing chamber in the cartridge receptacle, which is reversibly insertable into the beverage preparation machine, advantageously ensures that the mixing chamber is part of the replaceable cartridge system. In this way, contamination of the beverage preparation machine by the beverage substance is effectively avoided because only parts of the replaceable disposable or reusable cartridge system come into contact with the beverage substance.

According to a preferred embodiment of the present invention, provision is made for the cartridge system and in particular the cartridge receptacle to have at least one support structure which supports the sealing foil in the direction of the cartridge receptacle and in particular in the direction of the mixing cartridge. In this way, tearing of the sealing foil is prevented, in particular during pressure build-up in the reservoir during the beverage production process. The support structure comprises in particular a column-, bridge-, grid- or cylinder-shaped structure which projects from the bottom of the mixing chamber in the direction of the reservoir and on which the sealing foil partially rests.

According to a preferred embodiment of the present invention, provision is made for the piercing spike to comprise a cylindrical or frustoconical base part and a piercing part extending in the direction of the reservoir, wherein the piercing part is configured in the form of an obliquely cut truncated cone. Preferably, the piercing part is further configured such that an oblique cut surface of the obliquely cut truncated cone substantially faces the reservoir, wherein the oval periphery of the cut surface at least partially constitutes a cut edge for perforating the sealing element. It has been shown that the cut surface, which is generated by an oblique cut through the truncated cone, on the one hand cuts the sealing element easily and with sufficiently little force, and on the other hand does not separate any chips or loose pieces from the sealing element, which would otherwise contaminate the beverage in an undesirable manner. The sealing element perforation advantageously looks such that on that side of the piercing spike on which the maximum cutting edge projecting in the direction of the reservoir is formed, the material of the sealing element is cut with a smooth cut, while in the region of the cut surface of the piercing part the cut-off material of the sealing element is still connected to the remaining sealing element and is preferably rolled up or folded.

Preferably, the piercing spike comprises an intermediate part arranged between the base part and the piercing part, which is frustoconical in shape, wherein a circumferential shoulder is formed between the base part and the intermediate part and wherein a circumferential edge is formed between the piercing part and the intermediate part. Advantageously, a stable piercing spike is thus formed. The formation of the edge has the advantage that the lateral channels, insofar as they extend over the edge, have an enlarged entrance on the reservoir side and thus the transfer of the beverage substance in the direction of the mixing chamber is facilitated. The shoulder serves to abut against a stop of the spike guide when the piercing spike is in the retracted position, thus limiting the extension movement of the piercing spike in the direction of the cartridge.

According to a preferred embodiment of the present invention, provision is made for the cartridge receptacle to have a plurality of lateral channels, wherein each lateral channel extends parallel to the piercing spike in the region of the piercing part and in the region of the intermediate part. In this context, the lateral channels are each formed in particular in the form of a groove which is open on one side and is introduced into the outer surface of the piercing spike. Preferably, the lateral channels are at least partially formed in a circumferential region of the piercing spike that is rearward to the cut surface. This has the advantage that the lateral channels are arranged on the side of the sealing element perforation where a cut has been made in the material, and not on the opposite side where the cut material is still connected to the remaining sealing element. The beverage substance can thus flow comparatively unhindered into the lateral channels.

It is conceivable for the cross-section of the lateral channels and/or the number of lateral channels to be adapted to the viscosity of the beverage substance, so that the lateral channels control or limit the flow of the beverage substance towards the mixing chamber. At a high viscosity, several lateral channels or lateral channels with a larger cross-section are used, while at a lower viscosity, fewer lateral channels or lateral channels with a smaller cross-section are provided. There is thus a suitable cartridge receptacle for each cartridge.

According to a preferred embodiment of the present invention, provision is made for the piercing spike to have a twist prevention means in the form of a web protruding radially from the base part. Twisting of the piercing spike is thus advantageously avoided while it is being transferred from the retracted position into the extended position. It is also ensured that the lateral channels are arranged on that side of the piercing spike which faces away from the beverage outlet of the mixing chamber and in particular faces the fluid feed. In this way, improved mixing of the beverage substance and the fluid within the mixing chamber is achieved.

According to a preferred embodiment of the present invention, provision is made for the piercing spike to have an integrated compressed-air line, which is the cartridge emptying device, wherein the compressed-air line extends along the piercing spike in particular from a first end of the piercing spike to a second end of the piercing spike. In this way, three functions are advantageously integrated into the piercing spike: 1. The piercing spike comprises the piercing part in order to perforate the sealing element and thus to open the cartridge; 2. The piercing spike comprises the lateral channels in order to allow the beverage substance to be transferred into the mixing chamber; 3. The piercing spike comprises the integrated compressed-air line in order to blow compressed air into the reservoir, with the result that the beverage substance is pushed into the mixing chamber under pressure.

Preferably, a compressed-air connection for connecting to a compressed-air source is formed at the second end, and a compressed-air outlet for blowing compressed air into the reservoir is formed at the first end. The cartridge emptying device integrated into the cartridge receptacle thus comprises, within the meaning of the present invention, first of all only one compressed-air line, through which compressed air can be introduced into the reservoir from the outside. The cartridge receptacle is configured such that the beverage substance is pushed out of the reservoir into the mixing chamber by the compressed air. The compressed air is provided in particular by the beverage preparation machine. It is conceivable for a compressed-air source to be coupled directly to the compressed-air connection as soon as the cartridge system is inserted into the beverage preparation machine. This has the advantage that back-contamination in the direction of the beverage preparation machine is effectively avoided because the cartridge emptying device is immediately under pressure when the cartridge system is inserted and thus beverage substance is prevented from traveling in the direction of the compressed-air line and in particular in the direction of the compressed-air source of the beverage preparation machine. The beverage substance can thus move only in the direction of the mixing chamber from the reservoir.

According to a preferred embodiment of the present invention, provision is made for the compressed-air outlet to be configured as an opening in the cut face. This has the advantage that the air flowing into the reservoir is blown in on a side of the piercing spike that is remote from the lateral channels, such that the discharging of the beverage substance into the mixing chamber is not impeded. Preferably, a swirl thus forms in the reservoir, this favoring virtually residue-free emptying of the reservoir.

The compressed-air connection is configured in particular as an opening in the base part, wherein the base part is arranged in the cartridge receptacle such that the compressed-air connection is accessible from outside the cartridge receptacle. In this way, the connection of the compressed-air line to the compressed-air source is favored.

According to a preferred embodiment of the present invention, provision is made for the spike guide to have a guide part with an internal guide channel for receiving the piercing spike, wherein the guide channel of the guide part is configured in a substantially cylindrical or frustoconical manner, and wherein a circumferential stop is formed at an end of the guide part that faces the cartridge, said stop limiting the movement of the piercing spike in the direction of the reservoir, wherein the stop comprises in particular a region with a reduced diameter. In this way, reliable guiding of the piercing spike during the movement from the retracted position into the extended position is advantageously achieved. Preferably, a groove corresponding to the rib is formed as twist prevention means within the wall of the guide channel, such that undesired twisting of the piercing spike is prevented. The guide part is preferably arranged in the mixing chamber and protrudes from a bottom of the mixing chamber in the direction of the cartridge.

According to a preferred embodiment of the present invention, provision is made for the piercing spike to be configured as a plastic part and in particular as an injection-molded plastic part. This allows cost-effective production. In principle, however, it would alternatively also be conceivable to configure the piercing spike as a metal part.

According to a preferred embodiment of the present invention, provision is made for the piercing spike to be configured such that it is transferable from the retracted position into the extended position by a release element of the beverage preparation machine when the cartridge system is inserted into the beverage preparation machine.

According to a further preferred embodiment of the present invention, provision is made for the mixing chamber to have a beverage outlet through which the beverage formed from a blend of the beverage substance with the fluid is discharged, wherein the cartridge system is preferably configured such that the beverage is able to be introduced directly into a portable vessel from the beverage outlet. Advantageously, therefore, neither the beverage substance nor the produced beverage comes into contact with any part of the beverage preparation machine, and so any (back-)contamination of the beverage preparation machine is more or less avoided. The fluid is fed to the mixing chamber separately. Preferably, the fluid is introduced into the mixing chamber under pressure. The fluid is provided in particular by the beverage preparation machine. It is conceivable for a fluid source to be coupled directly to a corresponding fluid connection of the cartridge receptacle as soon as the cartridge system is inserted into the beverage preparation machine. The fluid connection is in this case fluidically connected to the mixing chamber via a fluid line. This has the advantage that back-contamination in the direction of the beverage preparation machine is effectively avoided because the fluid connection is immediately under pressure when the cartridge system is inserted and thus beverage substance is prevented from traveling in the direction of the fluid line and in particular in the direction of the fluid source of the beverage preparation machine. The beverage substance and the beverage can thus move only in the direction of the beverage outlet from the mixing chamber. The fluid comprises in particular water, preferably pressurized, cooled and/or carbonated drinking water.

According to a preferred embodiment of the present invention, provision is made for the mixing chamber to be provided with mixing structures. The mixing structures advantageously ensure improved mixing of beverage substance and fluid. For this purpose, the mixing structures are configured in particular such that the fluid flowing into the mixing chamber is swirled. It is conceivable for the mixing structure to comprise one or more mixing ribs which are arranged in the region of the fluid feed at the bottom of the mixing chamber and extend substantially perpendicular to the direction in which the fluid flows in. The mixing ribs thus act as barriers for the fluid, with the result that the fluid is swirled up and better mixing with the beverage substance is achieved.

According to a further preferred embodiment of the present invention, provision is made for the fluid feed to be supplied with fluid which is cooled by a refrigeration unit, wherein the refrigeration unit is part of the beverage preparation machine or of a separate refrigerator operatively connected to the beverage preparation machine. Advantageously, it is thus possible for cold beverages to be produced even when the cartridge is not cooled and is at room temperature for example. The integration of the system into an existing refrigerator has the advantage that the existing refrigeration unit of the refrigerator can be co-used easily in an efficient manner for the beverage preparation machine. In particular, in what are known as “side-by-side” refrigerators (often also referred to as American refrigerators), sufficient installation space for integrating the system is found in the front. It is conceivable for the beverage preparation machine to be a retrofitting set for such a refrigerator. The refrigeration unit comprises preferably a compressor cooling unit, an absorber cooling unit or a thermoelectric cooler.

According to a further preferred embodiment of the present invention, provision is made for the fluid feed to be supplied with fluid to which carbonic acid is added by a carbonator. It is conceivable for the carbonator to be part of the beverage preparation machine, and wherein the carbonator has a receptacle for a CO₂ cartridge and a feeding device for adding CO₂ from the CO₂ cartridge to the fluid. Advantageously, it is thus also possible to produce carbonated soft drinks with the system. Alternatively, it would also be conceivable for the carbonator to have an external CO₂ connection.

Further details, features and advantages of the invention are apparent from the drawings, and from the following description of preferred embodiments with reference to the drawings. The drawings illustrate merely exemplary embodiments of the invention which do not limit the essential concept of the invention.

### BRIEF DESCRIPTION OF THE DRAWINGS

FIGS. 1a to 1d show a perspective view, a schematic sectional view and the general operating principle of a cartridge system according to an exemplary first embodiment of the present invention.

FIG. 2 shows a schematic sectional view of a cartridge system according to an exemplary second embodiment of the present invention.

FIG. 3 shows a schematic sectional view of a cartridge system according to an exemplary third embodiment of the present invention.

FIGS. 4a and 4b show schematic views of a cartridge receptacle of a cartridge system according to an exemplary fourth embodiment of the present invention.

FIGS. 5a and 5b show schematic views of a cartridge receptacle of a cartridge system according to an exemplary fifth embodiment of the present invention.

FIG. 6 shows a schematic sectional view of a cartridge system according to an exemplary sixth embodiment of the present invention.

FIG. 7 shows a schematic detailed view of a cartridge system according to an exemplary seventh embodiment of the present invention.

### EMBODIMENTS OF THE INVENTION

In the various figures, identical parts are always provided with the same reference signs and are therefore each generally also mentioned only once.

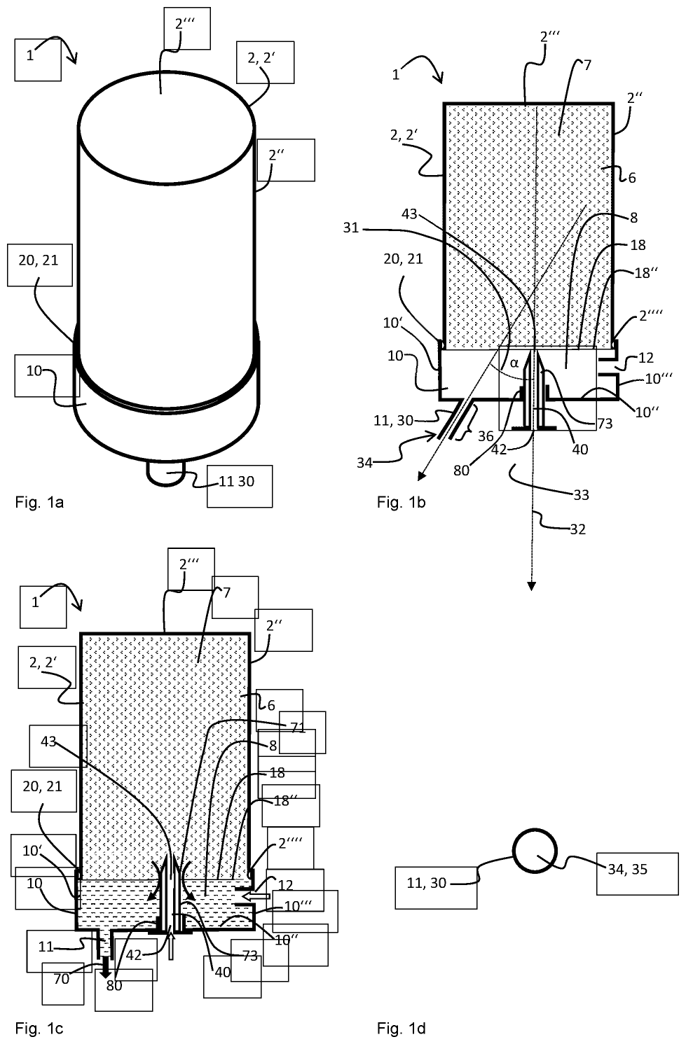

FIGS. 1a, 1b, 1c and 1d show a perspective view, a schematic sectional view and the general operating principle of a cartridge system 1 according to an exemplary first embodiment of the present invention.

The cartridge system 1 shown is provided to be inserted into a beverage preparation machine (not shown) for preparing a beverage 70. For this purpose, the cartridge system 1 has a cartridge 2, which is filled with a particular beverage substance 7, and a cartridge receptacle 10 connected to the cartridge 2. Within the beverage preparation machine 3, a corresponding beverage 70 is created with the aid of the beverage substance 7 and an additional water source, referred to as fluid source 41 in the following text. The cartridge 2 is in this case preferably filled with a pre-portioned quantity of beverage substance 7 which is necessary for creating a specific drinking portion, for example a drinking glass filling of the desired beverage 70. The beverage substance 7 is in particular a liquid and carbonated beverage concentrate in the form of syrup.

In principle, a plurality of different cartridge systems 1 are available, the cartridges 2 or reservoirs 6 of which are filled with different beverage substances 7 to produce different beverages 70. When the user of the system 1 wishes to drink a particular beverage 70, all he needs to do is choose, from the plurality of different cartridge systems 1, that cartridge system 1 which contains the corresponding beverage substance 7 for producing the desired beverage 70, insert it into a retaining unit of the beverage preparation machine and start the beverage production process at the beverage preparation machine, for example by pressing a start button, by touching a touch sensitive display in an appropriate manner, by gesture or voice control, or by means of a suitable application on a cell phone. It is also conceivable for the beverage production process to start automatically when the insertion of a new cartridge system 1 into the retaining unit 90 is detected. In each of the abovementioned cases, the desired beverage 70 is then produced automatically, conveyed into a drinking vessel and thus provided to the user. Subsequently, the used-up cartridge system 1 is removed and disposed of. The beverage preparation machine 3 is now ready once again to be filled with any desired new cartridge system 1 in order to produce a further beverage 70.

The beverage substance 7 preferably comprises liquid premixing constituents for soft drinks, such as caffeinated, carbonated, fruity and/or sugary sodas, syrups, concentrates and juices, non-carbonated beverages, beer (mixed) beverages, sparkling wine, or other alcoholic or non-alcoholic (mixed) beverages.

The cartridge system 1 comprises a cartridge 2 in the form of a cylindrical container. The container is hollow and thus contains a reservoir 6 for the beverage substance 7. The cartridge 2 is formed by a main body 2′, particularly made of plastic or aluminum, which is cup-shaped. Cup-shaped means here that the main body 2′ has a cartridge bottom 2′″ (shown above in the drawing) and a cartridge wall 2″ projecting at right angles from the cartridge bottom 2′″ in the direction of the cartridge receptacle 10. In this context, the cartridge wall 2″ has a cylindrical and circumferential configuration, while the cartridge bottom 2′″ in this example has a circular and disc-shaped configuration. The main body 2′ is deep-drawn during its manufacture (preferably from an aluminum sheet) and optionally stamped out (optionally first deep-drawn and then punched out or vice versa) so that the cartridge bottom 2′″ and the cartridge wall 2″ are joined together in one piece. Alternatively, it is also conceivable for the main body 2′ to be deep-drawn from a plastic foil or injection-molded from plastic during its manufacture. In principle, however, a cartridge made of glass would also be conceivable.

On a side opposite the cartridge bottom 2′″ in the axial direction, the main body 2′ is closed by a sealing element 18. In the first embodiment, the sealing element 18 comprises exclusively a sealing foil 18″, in particular a thin sealing foil, which closes the reservoir 6 so that the beverage substance 7 is sealed in an aroma-tight manner. For this purpose, the outer circumferential edge region of the sealing element 18 is fixed circumferentially to the edge 2″″ of the cartridge wall 2″. Preferably, the sealing element 18 is bonded, sealed or welded here to the edge 2″″ of the cartridge wall 2″. In particular, the sealing foil 18″ comprises a plastic foil, an aluminum foil or a multilayer foil made of plastic and/or aluminum.

The cartridge 2 is firmly or reversibly connected to the cartridge receptacle 10. The cartridge receptacle 10 is connected to the cartridge receptacle 10 in particular after the main body 2′ has been produced (deep drawing and punching), after the cartridge 2 has been filled with the beverage substance 7 and after the reservoir 6 has been closed by applying the sealing element 18. For this purpose, the cartridge wall 2″ optionally has circumferential connecting means 20, in particular in the form of a circumferential latching bead. The cartridge receptacle 10 optionally has mating connecting means 21 complementary to the connecting means 20, in particular in the form of a circumferential latching bulge, which latches into the latching bead when the cartridge 2 is connected to the cartridge receptacle 10. It is conceivable that the cartridge wall 2″ and the cartridge receptacle 10 are additionally bonded, welded and/or pressed together.

The cartridge is preferably configured such that it can withstand an internal pressure of up to 10 bar, particularly preferably up to 8 bar and most preferably up to 6 bar without bursting (at a temperature of 20° C. and an external pressure of 1 bar). The cartridge 2 is then preferably configured such that it can withstand an internal pressure of up to 10 bar, particularly preferably up to 8 bar and most preferably up to 6 bar without bursting (at a temperature of 20° C. and an external pressure of 1 bar). The reservoir 6 preferably has a volume of between 10 and 500 milliliters, particularly preferably between 30 and 90 milliliters and most preferably essentially 60 milliliters.

The cartridge receptacle 10 has a mixing chamber 8 which is fluidically connected to the reservoir 6 during the beverage production process, such that, with the aid of a cartridge emptying device of the cartridge receptacle 10, the beverage substance 7 can be transferred at least partially out of the reservoir 6 into the mixing chamber 8. The cartridge emptying device to this end comprises a compressed-air line 40. One end of the compressed-air line 40 is connected to a compressed-air connection 42 which can be connected to a compressed-air source of the beverage preparation machine in order to introduce compressed air into the compressed-air line 40, while the other end leads into a compressed-air outlet which is open in the direction of the reservoir 6 and introduces compressed air into the reservoir 6. The introduction of the compressed air causes the beverage substance 7 to be pushed into the mixing chamber 8.

A fluid feed 12 of the cartridge receptacle 10, which is supplied by a fluid source of the beverage preparation machine 3, also leads into the mixing chamber 8. It is conceivable for the fluid feed to have a quick coupling, by way of which the fluid feed 12 can be connected to the fluid source of the beverage preparation machine. The quick coupling can be configured for example such that, when the cartridge system 1 is inserted into the retaining unit, a fluidic connection is automatically established between the fluid source and the mixing chamber 8 via the fluid feed 12. During the beverage production process, fluid, in particular cooled and carbonated drinking water, passes from the fluid feed 12 into the mixing chamber 8 via this fluidic connection. Furthermore, during the beverage production process, beverage substance 7 passes from the reservoir 6 into the mixing chamber 8, as described above. As a result of the beverage substance 7 being blended with the fluid in the mixing chamber 8, the beverage 70 is formed, which then leaves the mixing chamber 8 through a beverage outlet 11.

The cartridge receptacle 10 has the beverage outlet 11, through which the beverage 70 produced within the mixing chamber 8 leaves the mixing chamber 8, and is conveyed in particular directly into the drinking vessel (not depicted), i.e. without parts of the beverage preparation machine coming into contact with the beverage 70. In this way, back-contamination of the beverage preparation machine 3 is prevented. The drinking vessel is arranged in particular directly beneath the beverage outlet 11.

In this context, the beverage outlet 11 is formed in particular exclusively by a tubular line piece 30. The line piece 30 is configured in the form of a closed channel with a circular cross-section 34 (cf. FIG. 1d). The channel extends rectilinearly along a main extension direction 31, which extends at an angle α to the longitudinal axis 32 of the cartridge 2. The angle α is between 5 and 85 degrees, preferably between 15 degrees and 75 degrees and particularly preferably between 25 and 65 degrees.

In the present example according to the first embodiment, the beverage substance 7 exemplarily comprises a particularly sugary and non-alcoholic syrup or a caffeinated concentrate. The angle α 33 is therefore in particular between 20 and 60 degrees, preferably between 25 and 55 degrees, particularly preferably between 30 and 50 degrees, and most particularly at substantially 40 degrees, in order to promote a visually appealing light foaming in the drinking vessel.

Optionally, mixing and/or swirling elements are arranged within the line piece 30.

The line piece 30 has a length 35 parallel to the main extension direction 31, which is between 2 and 40 millimeters, preferably between 3 and 20 millimeters, particularly preferably between 4 and 15 millimeters. Preferably, the length 35 is between 2 and 30 millimeters and preferably between 4 and 20 millimeters, since the beverage substance 7 contained in the cartridge 2 contains a particularly sugary and non-alcoholic syrup or a caffeinated concentrate.

Following completion of the beverage production process, the cartridge system 1 is removed from the retaining unit, such that the beverage production machine can be fitted with a new and unused cartridge system 1. The cartridge receptacle 10 can optionally be reused by being separated from the used cartridge 2 by releasing the latching connection, and being clip-fastened onto a new cartridge 2.

To establish the fluid connection between the reservoir 6 and the mixing chamber 8, the cartridge receptacle 10 has a spike guide 80 in which a piercing spike 73 is slidably mounted. The sealing element 18 is perforated by the displaceable piercing spike 73 being transferred between a retracted position, in which the piercing spike 73 is away from the sealing element 18 (cf. FIG. 1b), and an extended position, in which the piercing spike 73 pierces the sealing element 18 (cf. FIG. 1c) and projects into the reservoir 6.

The outer wall of the piercing spike 73 is provided with the plurality of lateral channels 71 for conveying the beverage substance 7 from the reservoir 6 in the direction of the mixing chamber 8 when the sealing element 18 is pierced. The lateral channels 71 are configured in the form of grooves that are open on one side and extend parallel to one another. Following the piercing of the sealing element 18, the lateral channels 71 become fluidically connected to the reservoir 6, such that the beverage substance 7 can flow around the edges of the pierced sealing element 18 in the direction of the mixing chamber 8.

The cross section of the lateral channels 71 and/or the number of the lateral channels 71 is in this case preferably adapted to the viscosity of the beverage substance 7, such that the lateral channels 71 control or limit the flow of the beverage substance 7 in the direction of the mixing chamber 8. At a high viscosity, a plurality of lateral channels 71 and/or lateral channels 71 with a relatively large cross section are used, while, at a lower viscosity, fewer lateral channels 71 and/or lateral channels 71 with a smaller cross section are provided.

The piercing spike 73 also incorporates the compressed air line 40, which functions as a cartridge emptying device. The compressed air line 40 opens into the reservoir 6 at the end of the piercing spike 73 when the piercing spike 73 is in the extended position.

On a side of the piercing spike 73 facing away from the reservoir 6 in particular, the compressed air connection 42 is formed, which can thus be accessed from outside the cartridge receptacle 10 and connected to the compressed air source of the beverage preparation machine.

Preferably, the piercing spike 73 is transferred from the retracted position to the extended position during or after insertion of the cartridge system 10 into the beverage preparation machine or after starting the beverage production process, preferably by a stationary release element of the retaining unit, against which the piercing spike 73 is pressed. The piercing spike 71 is preferably a plastic part and particularly preferably a plastic injection molded part.

Provision is preferably made for both the fluid source and the compressed-air source to be coupled directly to the fluid feed 12 and to the compressed-air connection 42, respectively, as soon as the cartridge system 1 is inserted into the beverage preparation machine or a beverage production process is started, and in particular before the sealing element 18 is pierced. In this way, back-contamination in the direction of the beverage preparation machine is effectively avoided because the fluid feed 12 and the cartridge emptying device are immediately under overpressure upon insertion of the cartridge system 1, and this prevents the beverage substance 7 from traveling in the direction of the fluid source and compressed-air source, respectively. The beverage substance 7 can thus move only in the direction of the mixing chamber 8 from the reservoir 6 as soon as the sealing element 18 is opened.

The cartridge receptacle 10 comprises a base structure 10′ with a cup-shaped configuration. The open side of this cup-shaped configuration points towards the cartridge 2 and at least partially receives the cartridge 2, in particular the edge 2″″ of the cartridge wall 2″. On an opposite bottom side 10″, the base structure 10′ has the beverage outlet opening 11 and the outwardly open spike guide 80. The fluid feed 12 is formed on a side wall 10″ of the basic structure 10′. The basic structure 10′ is configured in particular as a plastic part and especially preferably as a plastic injection-molded part.

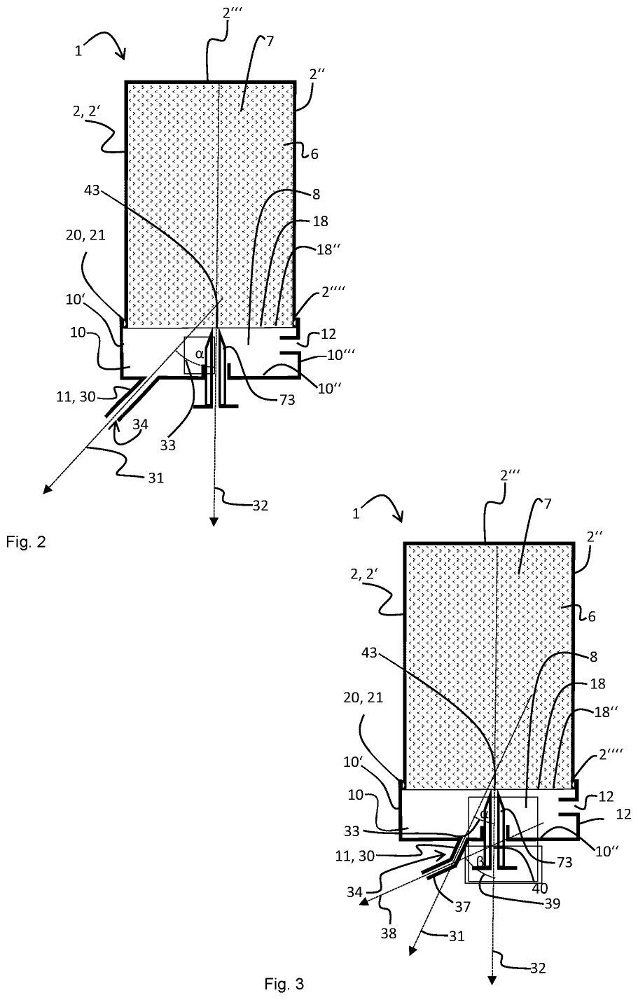

FIG. 2 shows a schematic sectional view of a cartridge system 1 according to an exemplary second embodiment of the present invention. The second embodiment is similar to the first embodiment illustrated and explained with reference to FIGS. 1a, 1b, 1c and 1d, wherein, in contrast to the first embodiment, the beverage substance 7 according to the second embodiment exemplarily comprises beer-containing or beer-like substances, tea or sparkling wine.

The angle α 33 is therefore in particular between 40 and 85 degrees, preferably between 60 and 85 degrees and particularly preferably between 70 and 80 degrees, so as to prevent excessive foaming in the drinking vessel. The length 35 is preferably between 10 and 30 millimeters and preferably between 15 and 25 millimeters.

Additionally, it would be conceivable for the shape of the cross-section 34 or the area of the cross-section 34 to change along the main extension direction 31 of the line piece 30 in the first and/or second embodiments.

FIG. 3 shows a schematic sectional view of a cartridge system 1 according to an exemplary third embodiment of the present invention. The third embodiment is similar to the first and second embodiments illustrated and explained with reference to FIGS. 1a to 1d and 2, wherein, in contrast, the beverage outlet 11 in the third embodiment comprises, in addition to the line piece 30, a further line piece 37 which adjoins the line piece 30 in the direction of flow of the beverage 70.

The main extension direction 38 of the further line piece 37 runs at an angle β 39 to a longitudinal axis 32 of the cartridge 2. In the transition region between the line piece 30 and the further line piece 37, a kink is provided, since the angle β 39 is not equal to the angle α 33. In the present example according to the third embodiment, the beverage substance 7 comprises beer or beer-like substances, tea or sparkling wine. The angle β 39 is therefore larger than the angle α 33 to avoid excessive foaming in the drinking vessel. It is conceivable for the angle α 33 to be between 10 and 60 degrees, preferably between 2 and 55 degrees, particularly preferably between 3 and 50 degrees, while the angle β 39 is between 40 and 85 degrees, preferably between 45 and 80 degrees, and particularly preferably between 50 and 70 degrees.

In particular, the further line piece 37 has a length parallel to its main extension direction 38, which comprises between 2 and 40 millimeters, preferably between 3 and 20 millimeters, particularly preferably between 4 and 15 millimeters. Optionally, the further line piece 37 comprises a channel open on one side towards the top, i.e. towards the cartridge 2.

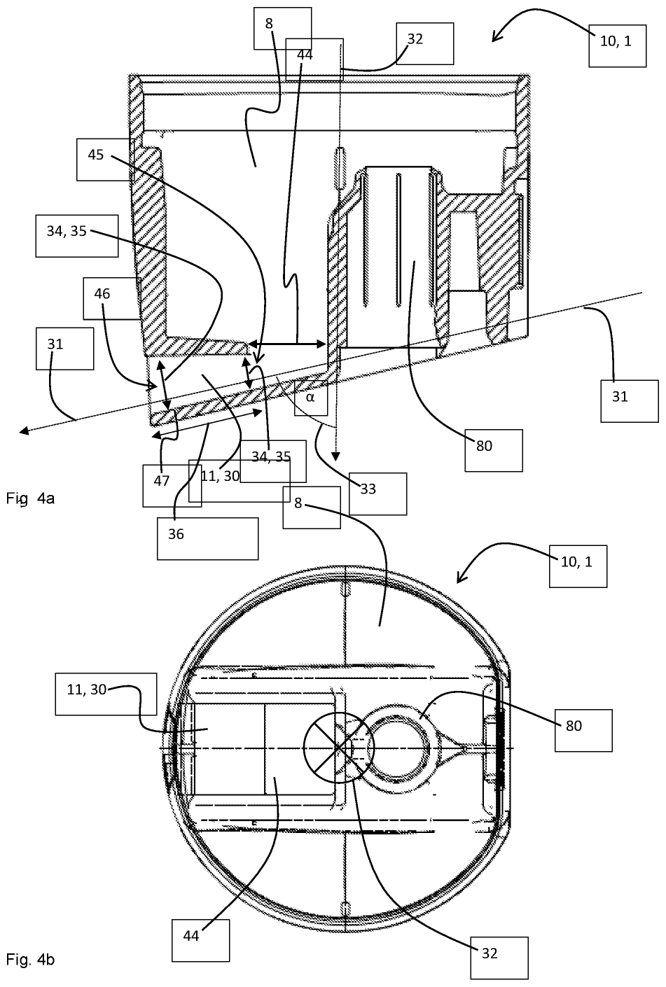

FIGS. 4a and 4b show schematic views of a cartridge system 1 according to an exemplary fourth embodiment of the present invention. The fourth embodiment is similar to the first embodiment illustrated and explained with reference to FIGS. 1a, 1b, 1c and 1d, wherein, in contrast, the line piece 30 in the fourth embodiment has an internal cross-section 34 perpendicular to its main direction of extension 31 with a cross-sectional area 35 that increases along the main direction of extension 31.

The angle α 33 is between 70 and 80 degrees and, in the present example, in particular 76 degrees, so that the beverage dispensing jet emerging from the line piece 30 is directed as far as possible against a wall of the drinking vessel (not shown) in order to prevent excessive foaming of the beverage, since the beverage substance 7 in this example again comprises beer-containing or beer-like substances, tea or sparkling wine. The main extension direction 31 of the line piece 30 is determined in particular by the lower wall/lower side 47 of the channel or of the line piece 30.

The inner cross-section 34 of the line piece 30 has a cross-sectional area 35 which is in particular round, oval or rectangular (with rounded corners). The cross-sectional area at the beginning 45 of the channel is in particular between 25 and 35 square millimeters, preferably about 30 square millimeters. The cross-sectional area at the end 46 of the channel, thus at the exit point of the beverage dispensing jet, is in particular between 70 and 90 square millimeters, preferably at about 77 square millimeters.

In particular, the length of the line piece 30 is between 5 and 15 millimeters, preferably at approximately 10 millimeters.

In the cartridge receptacle 10 according to the fourth embodiment, the interior of the line piece 30 is in fluid communication with the mixing chamber 8 through an inner opening 44. This inner opening 44 has a diameter of 7.5 to 8.5 millimeters.

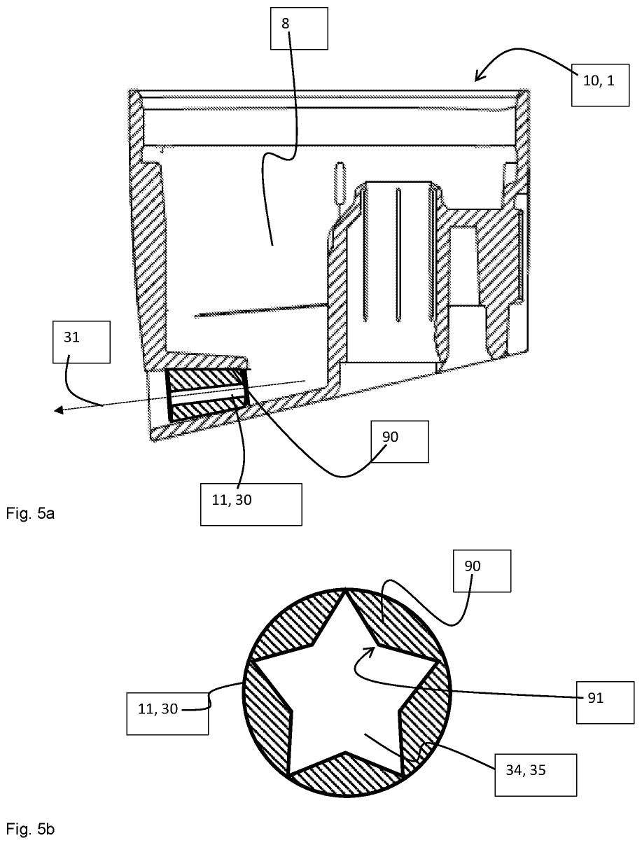

FIGS. 5a and 5b illustrate schematic views of a cartridge receptacle 10 of a cartridge system 1 according to an exemplary fifth embodiment of the present invention.

The fifth embodiment is similar to the fourth embodiment illustrated and explained with reference to FIGS. 4a and 4b, wherein, in contrast, the line piece 30 has an inner contour 90 which extends partially along the main extension direction 31 of the line piece 30. This inner contour has a star-shaped inner cross-section, so that the cross-section of the line piece 34 is also star-shaped in this region. The inwardly projecting edges 91 of the inner contour 90 thereby form edges or tips (in cross-section) for bursting the foam bubbles of the beverage, which is accompanied by reduced foaming.

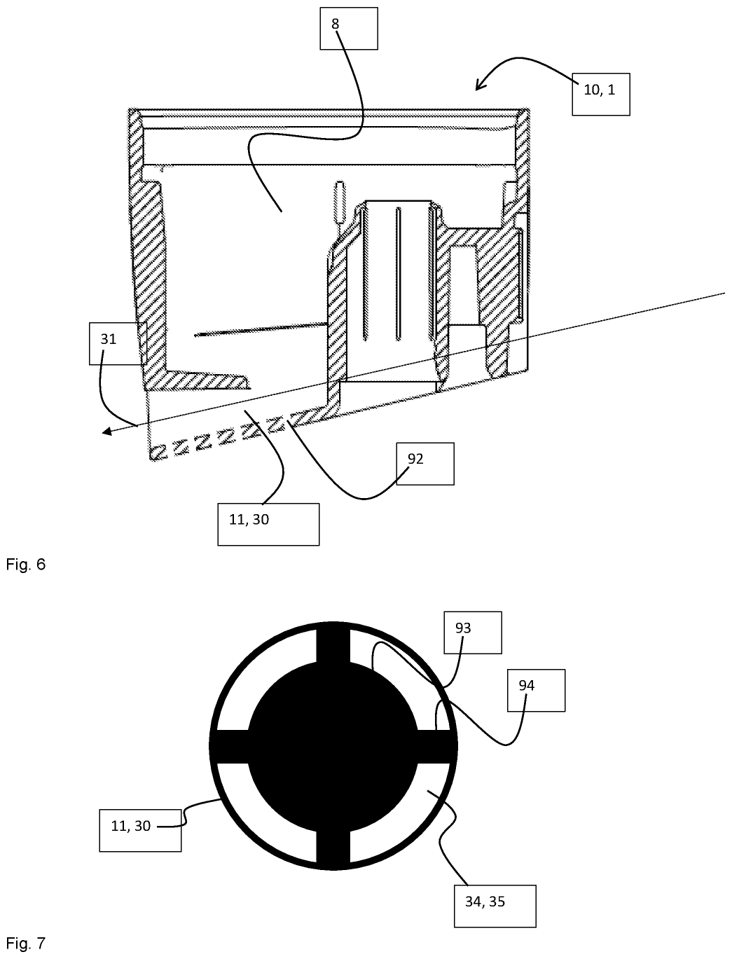

FIG. 6 illustrates a schematic sectional view of a cartridge system 1 according to an exemplary sixth embodiment of the present invention.

The sixth embodiment is similar to the fourth embodiment illustrated and explained with reference to FIGS. 4a and 4b, wherein, in contrast, the wall of the line piece 30 is provided with a plurality of relief openings 92. It is conceivable for the diameter or the number of the relief openings 92 to increase along the main extension direction 31, thus in the direction from the mixing chamber to the drinking vessel.

In a preferred manner, a more continuous pressure reduction thus takes place in the line piece 30, whereby an increased foaming is advantageously avoided in the case of strongly foaming beverage substances, such as beer-containing or beer-like substances, tea or sparkling wine, for a reduced foaming in the drinking vessel.

Alternatively, the wall could also be porous, with the porosity increasing along the main extension direction 31.

FIG. 7 shows a schematic detailed view of a cartridge system 1 according to an exemplary seventh embodiment of the present invention.

The sixth embodiment is similar to the first embodiment illustrated and explained with reference to FIGS. 1a, 1b, 1c and 1d, wherein in FIG. 7—as in FIG. 1d—the cross-section of the line piece 30 can be seen. In contrast to the first embodiment, in the sixth embodiment a baffle element 93 is arranged in the line piece 30.

This baffle element 93 serves as an additional mixing and/or swirling element and ensures additional swirling when the beverage is passed through the line piece 30 by the flow of the beverage liquid bouncing on the baffle element 93. In this way, additional foaming is advantageously induced in particular with low-foaming beverage substances, such as in particular sugary and non-alcoholic syrup or caffeinated concentrates.

The baffle element 93 is attached to the wall of the line piece 30 via lateral webs 94 to hold the baffle element 93 in the center of the line piece 30.

### LIST OF REFERENCE SIGNS

1 Cartridge system
2 Cartridge
2′ Main body
2″ Cartridge wall
2′″ Cartridge bottom
2″″ Edge of the cartridge wall
6 Reservoir
7 Beverage substance
8 Mixing chamber
10 Cartridge receptacle
10′ Base structure
10″ Bottom side
10′″ Side wall of the base structure
11 Beverage outlet
12 Fluid feed
18 Sealing element
18′ Through-opening
18″ Sealing foil
18′″ Sealing body
19 Partial area
20 Connecting means
21 Mating connecting means
22 Support structure
23 Longitudinal seam
24 Lid body
30 Tubular line piece
31 Main extension direction of the line piece
32 Longitudinal axis of the cartridge
33 Angle α
34 Cross-section of the line piece
35 Cross-sectional area
36 Length of the line piece
37 Further line piece
38 Main extension direction of the further line piece
39 Angle β
40 Compressed-air line
42 Compressed-air connection
43 Compressed-air outlet
44 Inner opening
45 Beginning of the channel
46 End of the channel
47 Lower side of the channel/line piece
71 Lateral channel
70 Beverage
73 Piercing spike
80 Spike guide
90 Inner contour
91 Edge
92 Relief opening
93 Baffle element
94 Webs

1. A cartridge system for producing a beverage, wherein the cartridge system is insertable into a beverage preparation machine, has a cartridge comprising a reservoir filled with a beverage substance and a cartridge receptacle connected to the cartridge, wherein the cartridge receptacle has a mixing chamber which can be brought into fluid communication with the reservoir and a fluid feed opening into the mixing chamber, wherein the mixing chamber has a beverage outlet through which the beverage made from a mixture of the beverage substance with the fluid supplied through the fluid feed in the mixing chamber is discharged, wherein the beverage outlet has a tubular line piece, wherein the line piece is configured such that a main extension direction of the line piece extends at an angle α to a longitudinal axis of the cartridge.

2. The cartridge system as claimed in claim 1, wherein the angle α is between 5 and 85 degrees, preferably between 15 degrees and 75 degrees, and particularly preferably between 25 and 65 degrees.

3. The cartridge system as claimed in claim 1, wherein the angle α is between 40 and 85 degrees, preferably between 60 and 85 degrees and particularly preferably between 70 and 80 degrees, in particular if the beverage substance comprises beer-containing or beer-like substances, tea, or sparkling wine.

4. The cartridge system as claimed in claim 1, wherein the angle α is between 20 and 60 degrees, preferably between 25 and 55 degrees, particularly preferably between 30 and 50 degrees and most particularly at substantially 40 degrees, in particular if the beverage substance contains a particularly sugary and non-alcoholic syrup or a caffeinated concentrate.

5. The cartridge system as claimed in claim 1, wherein the angle α changes along the main extension direction of the line piece, in particular decreases or increases.

6. The cartridge system as claimed in claim 1, wherein the line piece has an inner cross-section perpendicular to its main extension direction, which has an oval, circular, angular, triangular, quadrangular, pentagonal, hexagonal, octagonal, trapezoidal, star-shaped, slit-shaped, and/or annular shape.

7. The cartridge system as claimed in claim 6, wherein the line piece has an inner contour for bursting foam bubbles, preferably in a form of an edge or tip extending in the main extension direction.

8. The cartridge system as claimed in claim 6, wherein the shape of the cross-section or an inner contour changes along the main extension direction of the line piece, in particular from an angular or slit-shaped shape to a round or oval shape.

9. The cartridge system as claimed in claim 1, wherein the line piece has an inner cross-section perpendicular to its main extension direction, a cross-sectional area of which changes along the main extension direction of the line piece, in particular decreases or increases.

10. The cartridge system as claimed in claim 9, wherein the cross-sectional area is between 5 and 200 square millimeters, preferably between 10 and 150 square millimeters, and more preferably between 25 and 125 square millimeters.

11. The cartridge system as claimed in claim 9, wherein the cross-sectional area is between 50 and 200 square millimeters, preferably between 75 and 150 square millimeters, in particular if the beverage substance comprises beer-containing or beer-like substances, tea, or sparkling wine.

12. The cartridge system as claimed in claim 9, wherein the cross-sectional area is between 10 and 125 square millimeters, preferably between 50 and 100 square millimeters, in particular if the beverage substance contains a particularly sugary and non-alcoholic syrup or a caffeinated concentrate.

13. The cartridge system as claimed in claim 1, wherein the line piece has a length parallel to its main extension direction, being between 2 and 40 millimeters, preferably between 3 and 20 millimeters, more preferably between 4 and 15 millimeters.

14. The cartridge system as claimed in claim 13, wherein the length is between 10 and 30 millimeters, and preferably between 10 and 20 millimeters, in particular if the beverage substance comprises beer-containing or beer-like substances, tea, or sparkling wine.

15. The cartridge system as claimed in claim 13, wherein the length is between 2 and 30 millimeters, and preferably between 5 and 10 millimeters, in particular if the beverage substance contains a particularly sugary and non-alcoholic syrup or a caffeinated concentrate.

16. The cartridge system as claimed in claim 1, wherein the line piece has a length and an inner cross-section, wherein a shape of the cross-section and/or the angle α and/or a cross-sectional area and/or the length and/or an inner contour is formed as a function of the beverage substance.

17. The cartridge system as claimed in claim 1, wherein mixing and/or swirling elements, in particular at least one baffle element, are arranged within the line piece.

18. The cartridge system as claimed in claim 1, wherein the beverage outlet consists exclusively of the tubular line piece.

19. The cartridge system as claimed in claim 1, wherein the line piece has a wall that is permeable to air and, in particular, porous or penetrated by at least one relief opening.

20. The cartridge system as claimed in claim 19, wherein porosity of the wall and/or number of relief openings in the wall and/or diameter of the relief openings changes along the main extension direction, and preferably increases.

21. The cartridge system as claimed in claim 1, wherein the beverage outlet comprises a further line piece which adjoins the tubular line piece in a direction of flow.

22. The cartridge system as claimed in claim 21, wherein the further line piece is configured as a channel piece that is open on one side and, in particular, is configured to be open at the top.

23. The cartridge system as claimed in claim 22, wherein the further line piece is configured as a closed channel with an inner cross-section perpendicular to its main extension direction, which has an oval, circular, angular, triangular, quadrangular, pentagonal, hexagonal, octagonal, trapezoidal, star-shaped, slit-shaped, and/or annular shape.

24. The cartridge system as claimed in claim 21, wherein the further line piece is configured such that a main extension direction of the further line piece is at an angle β to a longitudinal axis of the cartridge, wherein the angle β is not equal to the angle α.

25. The cartridge system as claimed in claim 24, wherein the angle β is larger than the angle α, in particular if the beverage substance comprises beer-containing or beer-like substances, tea, or sparkling wine.

26. The cartridge system as claimed in claim 24, wherein the angle β is smaller than the angle α, in particular if the beverage substance contains a particularly sugary and non-alcoholic syrup or a caffeinated concentrate.

27. The cartridge system as claimed in claim 24, wherein the angle α is between 10 and 60 degrees, preferably between 2 and 55 degrees, more preferably between 3 and 50 degrees, and the angle β is between 40 and 85 degrees, preferably between 60 and 85 degrees, and more preferably between 70 and 80 degrees, in particular if the beverage substance comprises beer-containing or beer-like substances, tea, or sparkling wine.

28. The cartridge system as claimed in claim 21, wherein the further line piece has a length parallel to its main extension direction, comprising between 2 and 40 millimeters, preferably between 3 and 20 millimeters, particularly preferably between 4 and 15 millimeters.

29. The cartridge system as claimed in claim 28, wherein the line piece has a length parallel to its main extension direction, which is between 2 and 10 millimeters, and the further line piece has a length parallel to its main extension direction, which is between 10 and 20 millimeters, in particular if the beverage substance comprises beer-containing or beer-like substances, tea, or sparkling wine.

30. The cartridge system as claimed in claim 21, wherein the further line piece has an inner contour for bursting foam bubbles, preferably in a form of an edge or tip extending in the main extension direction.

31. The cartridge system as claimed in claim 30, wherein a shape of the inner contour changes along the main extension direction of the further line piece, in particular from an angular or slit shape to a round or oval shape.

32. The cartridge system as claimed in claim 21, wherein the further line piece has a wall which is permeable to air and, in particular, porous or penetrated by at least one relief opening.

33. The cartridge system as claimed in claim 32, wherein porosity of the wall and/or number of relief openings in the wall and/or diameter of the relief openings changes and preferably increases along the main extension direction.

34. The cartridge system as claimed in claim 1, wherein the beverage outlet has a flow resistance adapted to the beverage substance.

35. The cartridge system as claimed in claim 34, wherein the line piece has a flow resistance which differs from a flow resistance of the further line piece, preferably wherein the flow resistance of the line piece is greater than the flow resistance of the further line piece, in particular if the beverage substance comprises beer-containing or beer-like substances, tea, or sparkling wine
